(19) United States
(12) Patent Application Publication
(10) Pub. No.: US 2018/0272555 A1
(43) Pub. Date: Sep. 27, 2018

(54) ADJUSTABLE FEATHERBOARD WITH ANTI-KICKBACK DEVICE

(71) Applicant: Dennis Mas, South Pittsburg, TN (US)

(72) Inventor: Dennis Mas, South Pittsburg, TN (US)

(21) Appl. No.: 15/464,881

(22) Filed: Mar. 21, 2017

(51) Int. Cl. B27B 25/10; B23D 47/04; B23Q 3/00

(52) U.S. Cl. CPC B27B 25/10; B23Q 3/002; B23D 47/04

(57) ABSTRACT

An adjustable featherboard device includes an elongated bar having a shape and size that is suitable for engaging the miter slot of a table saw. An elongated featherboard body is pivotally secured onto the top of the bar and rotates 360 degrees along a horizontal plane. The featherboard body includes a first end for imparting a lateral force onto a side section of a piece of stock located on the table saw. An anti-kickback member is pivotally secured along one side of the featherboard body adjacent to the first end. The anti-kickback member includes a cam body having a notch section and a protruding section for engaging a top surface of the piece of stock.

### TECHNICAL FIELD

The present invention relates generally to table saw accessories, and more particularly to an adjustable featherboard with an anti-kickback device for guiding stock along a saw to be cut.

### BACKGROUND

The statements in this section merely provide background information related to the present disclosure and may not constitute prior art.

A table saw typically includes a motor-driven circular saw blade centrally mounted beneath a generally horizontal saw table having a blade slot through which the saw blade protrudes. A rip fence comprising an elongated raised bar is slidingly connected to the table, and is oriented parallel with the saw blade. An elongated miter slot is formed in the surface of the table on the opposite side of the blade slot, and is also oriented in a parallel direction to the saw blade. The miter slot typically extends the length of the saw table and includes a shape and size that is suitable for receiving accessories such as a miter gauge or featherboard, for example.

Although current featherboard designs work well to impart a constant pushing force against stock such as wood, for example, that has perfectly straight side edges, they do not work well with materials that do not have straight side edges. Indeed, in such situations it is not uncommon for the distal end of the featherboard to lose contact with the side of the material. When this occurs, the user must stop the cutting process, loosen the featherboard, adjust the length of the featherboard to make contact with the uneven side of the material, retighten the featherboard, and then continue the cutting process. Such a requirement often leads users to simply continue the cutting process without the aid of the featherboard.

Even when the material does have straight side edges, it is not uncommon for the material to move vertically when being engaged by the saw blade. Unfortunately, when this situation occurs, the above described featherboards do nothing to prevent a dangerous kickback situation. Lastly, current featherboard designs always position a portion of the main body at an offset orientation with the miter slot. As such, it is not possible to utilize the entire space between the slot and the cutting blade, thereby reducing the shape and size of material(s) that can be used with the same.

The present invention, directed to an adjustable featherboard with an integrated anti-kickback device differs from the conventional art in a number of aspects. The manner by which will become more apparent in the description which follows, particularly when read in conjunction with the accompanying drawings.

### SUMMARY OF THE INVENTION

The present invention is directed to an adjustable featherboard with an anti-kickback device. One embodiment of the present invention can include an elongated bar having a shape and size that is suitable for being positioned within, and sliding along a length of the miter slot of a table saw. An elongated featherboard body can be pivotally secured onto the top of the bar and can pivot 360 degrees along a horizontal plane. The featherboard body can include a first end for imparting a lateral force onto a side section of a piece of stock located on the table saw.

Another embodiment of the present invention can include an anti-kickback member that is pivotally secured along one side of the featherboard body adjacent to the first end. The anti-kickback member including a cam body having a notch section and a protruding section that are configured to engage a top surface of the piece of stock.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of the adjustable featherboard with anti-kickback device that is useful for understanding the inventive concepts disclosed herein.

FIG. 2 is a perspective view of the adjustable featherboard with anti-kickback device in accordance with one embodiment of the invention.

FIG. 3 is a top view of the adjustable featherboard with anti-kickback device in operation, in accordance with one embodiment of the invention.

FIG. 4 is a perspective view of the adjustable featherboard with anti-kickback device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described and illustrated for use with a table saw, those of skill in the art will recognize that the adjustable featherboard device can be utilized with any number of different power tools used to cut, engrave, drill, adjust or otherwise manipulate a piece of stock such as wood, for example. Therefore, the inventive concepts disclosed herein are not to be construed as limiting to use with a table saw.

As described herein, the term “pivotally secured” “rotatably secured” and derivatives thereof shall be used interchangeably to describe a situation wherein two identified objects are joined together in a manner that allows one or both of the objects to pivot, and/or rotate about or in relation to the other object in either a horizontal and/or vertical manner. Several nonlimiting examples of connectors for pivotally connecting objects together include traditional single hinge mechanisms, pivoting couplers, and/or swivel flanges, for example.

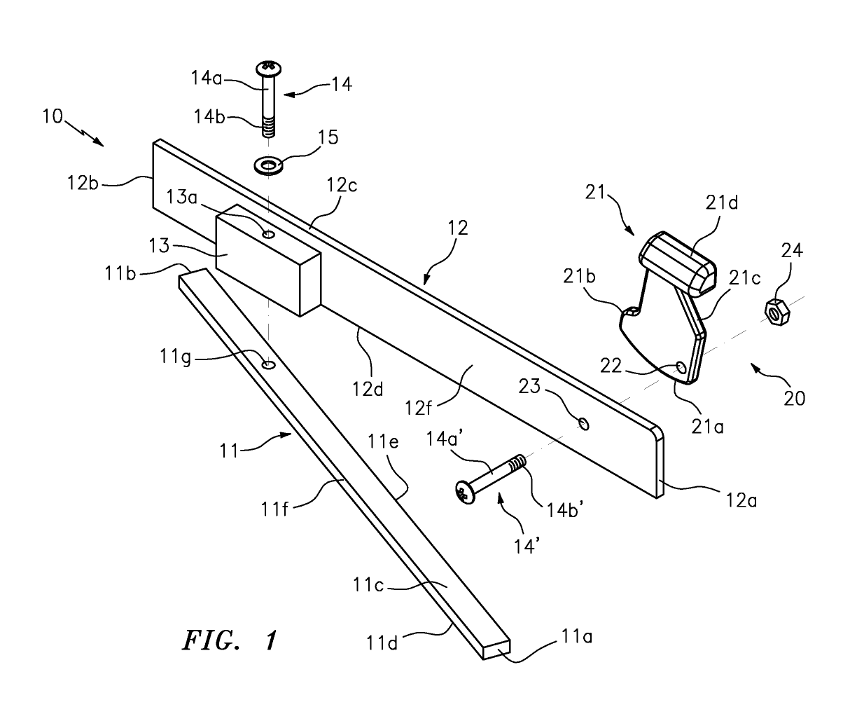

FIGS. 1-4 illustrate various embodiments of an adjustable featherboard device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 is an exploded parts view of an adjustable featherboard with anti-kickback device 10 that includes, essentially, a sliding bar 11 that is pivotally connected to a lateral featherboard 12 having an anti-kickback member 20 positioned along one end thereof.

The sliding bar 11 can include an elongated generally rectangular member having a first end 11a, a second end 11b, a top surface 11c, a bottom surface 11d, and a pair of side surfaces 11e and 11f forming a shape and size that is suitable for being positioned within, and sliding along the length of a miter slot 2 of a conventional table saw 1 (i.e., slidingly engage).

The lateral featherboard body 12 can also include or comprise an elongated, generally rectangular shaped member having a first end 12a, a second end 12b, a top surface 12c, a bottom surface 12d, and a pair of elongated sides 12e and 12f. A protrusion 13 can extend outward from the elongated side 12f and can include an aperture 13a extending from the top surface through the bottom surface thereof. As the first end 12a of the featherboard body is intended to make contact with a piece of stock, this end can include any number of different shapes, such as a flat edge, rounded edge or tapered edge.

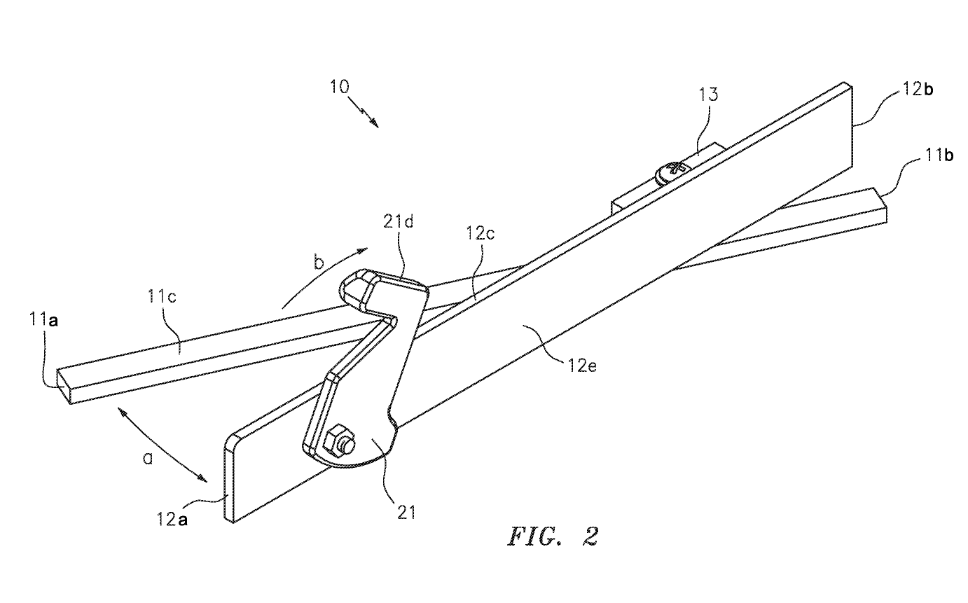

In one embodiment, the lateral featherboard body 12 can be pivotally secured onto the sliding bar 11 via an elongated fastener 14. As shown, the shank 14a of the fastener 14 can extend through the aperture 13a and the threaded end 14b can engage a threaded opening 11g along the top surface of the sliding bar 11c. A washer 15 can separate the head of the fastener 14 from the top of the protrusion 13. When so positioned, the first end 12a of the lateral featherboard body can rotate horizontally 360 degrees relative to the fastener 14 (see arrow a in FIG. 2).

Although described above as including a protruding block 13 for receiving a threaded fastener 14, the inventive concepts are not limited to such an arrangement. To this end, other embodiments are contemplated wherein the block 13 is removed, and the aperture 13a and fastener 14 pass through the top and bottom surfaces of the featherboard body 12 itself. Moreover, any number of other types of connectors that are capable of pivotally securing the featherboard body 12 and the sliding bar 11 together are also contemplated for use herein.

The anti-kickback member 20 can include a main body/cam 21 that preferably includes a curved bottom section 21a, a nub section 21b, a notched section 21c, and a lateral protruding section 21d. In one embodiment, the cam 21 is secured onto the side 12e of the featherboard body adjacent to the first end 12a via a second fastener 14′ having a shank 14a′ that extends through apertures 22 and 23 located along the cam 21 and featherboard 12, respectively. The threaded end 14b′ of the shank can be engaged by a locknut 24, so as to allow the cam 21 to rotate vertically about the fastener 14′.

As shown best in FIG. 2, the anti-kickback member can be positioned in the open configuration when the same is not being utilized. When so positioned, the cam body can be rotated via the nub section 21b toward the first end of the featherboard body (see arrow b) until the lateral protruding section 21d is in contact with the top of the featherboard body 12c. Such a feature positions the notched section 21c above the featherboard body so as to not make contact with a piece of stock.

As described herein, each of the sliding bar 11, the featherboard body 12 and the cam body 21 may be formed from materials that are, for example, relatively strong and stiff for their weight. Several nonlimiting examples include, but are not limited to various metals or metal alloys (e.g., aluminum, steel, titanium, or alloys thereof), a plastic/polymer (e.g., high-density polyethylene (HDPE) or polyethylene terephthalate (PET)), or a composite material (e.g., carbon fibers in a polymer matrix, fiberglass, etc.).

While the dimensions of the elements are not critical, in the preferred embodiment the sliding bar 11 can include a length (e.g., distance between first end 11a and second end 11b) of approximately 14.5 inches; a height (e.g., distance between top surface 11c and bottom surface 11d) of approximately ⅜ inches; and a width (e.g., distance between side surfaces 11e and 11f) of approximately ¾ inches. Such dimensions being advantageous for positioning the sliding bar within the standardized miter slot of a conventional table saw.

Likewise, the featherboard body 12 can include a length (e.g., distance between first end 12a and second end 12b) of approximately 14.5 inches; a height (e.g., distance between top surface 12c and bottom surface 12d) of approximately 2 inches; and a width (e.g., distance between side surfaces 12e and 12f) of approximately ¼ inches.

Although described above with regard to particular shapes, sizes, construction materials and dimensions, this is for illustrative purposes only. As such, those of skill in the art will recognize that any number of other shapes, sizes, construction materials and/or dimensions can be utilized without undue experimentation.

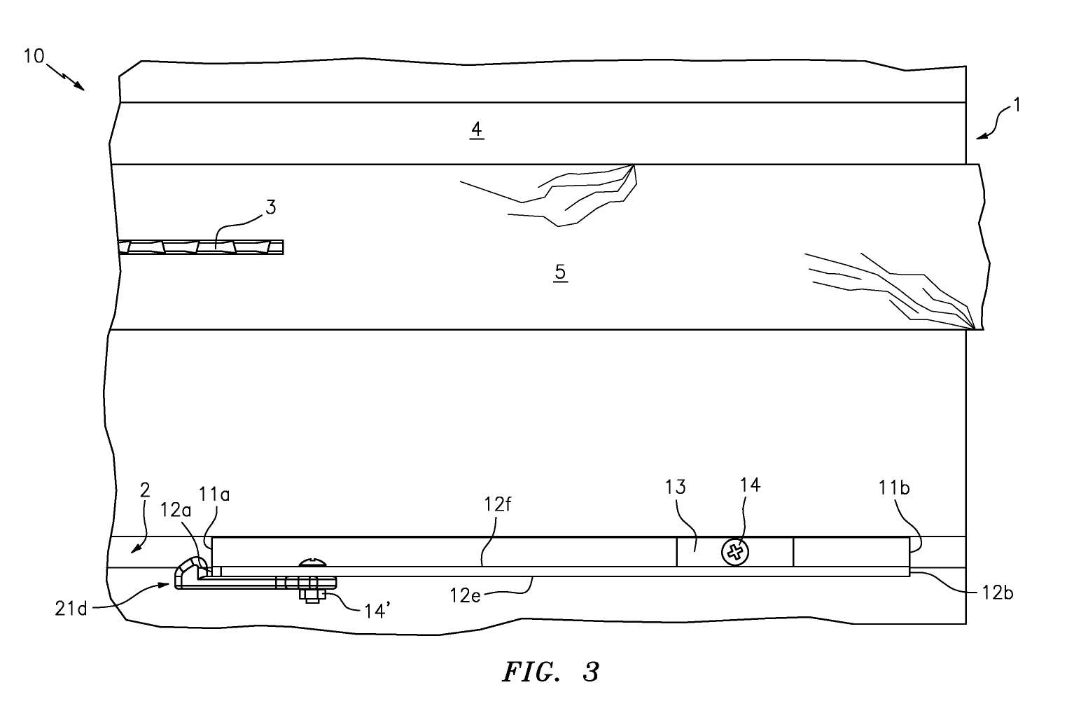

FIG. 3 illustrates one embodiment of the device 10 in operation with a table saw 1 that is cutting a piece of stock 5. As shown, the sliding bar 11 can be positioned within, and slid along the length of the miter slot 2, with the first end 11a nearest the saw blade 3. When so positioned, the entire featherboard body 12 is positioned on the opposite side of the miter slot 2 as the saw blade 3. Such a feature advantageously allows the featherboard device 10 to not occupy any of the table space between the miter slot 2 and the rip fence 4, thereby allowing the device 10 to be used with larger pieces of stock.

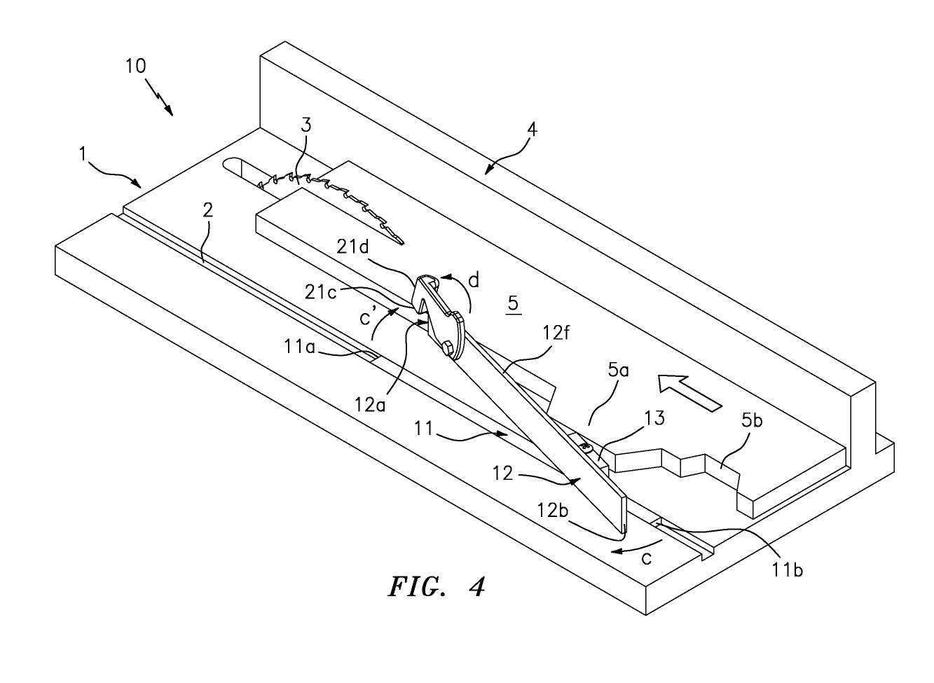

As shown in FIG. 4, when the stock is ready to be cut, a user can rotate (see arrow c) the second end of the lateral featherboard body 12a away from the stock 5. This action causes the first end of the featherboard body to rotate toward the stock 5 (see arrow c′) until making contact with the same. Next, the lateral protrusion 21d which extends horizontally beyond the side wall 12f of the featherboard body can be rotated forward (see arrow d) until the notched section 21c makes contact with the top surface of the piece of stock.

As the stock is fed toward the saw blade 3, the continual lateral force c′ imposed on the stock functions to keep the same secured against the rip fence 4 of the table, while the anti-kickback device prevents the stock from moving vertically.

Moreover, because the user is imparting a force (arrow c) that is directed away from the saw blade, the device does not need to be tightened between movements. As such, when the first end of the featherboard body 12a encounters an uneven surface of the stock, such as that illustrated at 5a and 5b, the user can rotate the second end of the featherboard body 12b in an inverse direction, so as to adjust the lateral force c′ applied onto the stock. Such a feature advantageously allows the device to adjust to any shape stock, without requiring the user to make an adjustment to the fastening mechanism.

As described herein, various embodiments of the adjustable featherboard with anti-kickback device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. (canceled)

2. The device of claim 8, further comprising:
an anti-kickback member having a cam body that is pivotally secured along the first side of the elongated planar member at a location adjacent to the first end,
wherein the anti-kickback member pivots vertically between an open orientation and a closed orientation.

3. The device of claim 2, wherein the cam body includes a lateral protruding section that in the closed orientation engages a top surface of the piece of stock to prevent an vertical movement of the same.

4. (canceled)

5. The device of claim 8, further comprising:
a protrusion that extends outward from the second side of the elongated planar member;
an aperture that extends through the protrusion; and
a threaded opening that is disposed along a top surface of the bar.

6. The device of claim 5, wherein the fastener includes an elongated shank that is positioned within the aperture; and
a threaded end that engages the threaded opening.

7. The device of claim 8, wherein the sliding bar comprises a length that is identical to a length of the elongated planar member.

8. A featherboard device for guiding a piece of stock along a power tool, said featherboard device comprising:
a sliding bar having a shape and size that is suitable for being completely positioned within a slot of the power tool;
an elongated planar member pivotally coupled with the sliding bar, wherein the elongated planar member is configured to freely move from a first position to a second position and back towards the first position as the piece of stock is guided along the power tool, wherein the elongated planar member is positioned away from a first area between the slot and the piece of stock when in the first position, wherein a first end of the elongated planar member is positioned in the first area when in the second position.

9. The featherboard device of claim 8, wherein the sliding bar is substantially ⅜ inches high.

10. The featherboard device of claim 8, wherein there is no locking device between the sliding bar and the elongated planar member.

11. The featherboard device of claim 10, wherein there is no biasing device between the sliding bar and the elongated planar member.

12. A method for guiding a piece of stock along a power tool, the method comprising:
providing a sliding bar pivotally coupled with a generally rectangular shaped planar member, wherein the planar member comprises a first end and a second end;
positioning the sliding bar within a slot of the power tool;
placing user's hand on the second end of the planar member and pulling the second end of the planar member away from the piece of stock to position the first end of the planar member in contact with a side portion of the piece of the stock.
